(19) United States
(12) Patent Application Publication
(10) Pub. No.: US 2015/0336221 A1
(43) Pub. Date: Nov. 26, 2015

(54) TOOL FOR ASSEMBLING COMPONENTS AND SYSTEM AND METHOD FOR SAME

(71) Applicant: GM GLOBAL TECHNOLOGY OPERATIONS LLC, Detroit, MI (US)

(72) Inventor: Neil David Mc Kay, Chelsea, MI (US)

(73) Assignee: GM GLOBAL TECHNOLOGY OPERATIONS LLC, Detroit, MI (US)

(21) Appl. No.: 14/700,883

(22) Filed: Apr. 30, 2015

Related U.S. Application Data
(60) Provisional application No. 62/008,658, filed on Jun. 6, 2014.
(60) Provisional application No. 62/000,829, filed on May 20, 2014.

(51) Int. Cl. B23K 37/04; B23K 26/12; B23K 31/02

(52) U.S. Cl. CPC B23K 37/0435; B23K 37/0408; B23K 31/02; B23K 26/12

(57) ABSTRACT

A tool for assembling first and second components includes a tool body having a first roller element rotatably mounted to the tool body and rotatable about a first axis of rotation. A second roller element is rotatably mounted to the tool body and is rotatable about a second axis of rotation nonparallel with the first axis of rotation. A third roller element is rotatably mounted to the tool body and is rotatable about a third axis of rotation nonparallel with the first axis of rotation. The second and third roller elements define a gap between one another. At least one clamping device provides clamping force directing one of the second and the third roller elements toward the gap. A weld head is operatively connected to the tool body. A system and method are provided for welding components to one another using the tool.

### CROSS-REFERENCE TO RELATED APPLICATIONS

This application claims the benefit of U.S. Provisional Application No. 62/008,658, filed Jun. 6, 2014, and U.S. Provisional Application No. 62/000,829, filed May 20, 2014, which is hereby incorporated by reference in its entirety.

### TECHNICAL FIELD

The present teachings generally include a tool, a system, and a method for assembling multiple component items, such as but not limited to vehicle body components, boats, construction equipment, lawn equipment, or robots.

### BACKGROUND

Vehicle bodies are comprised of a multitude of structural components that must be assembled to one another with sufficient precision for proper function and aesthetics. The vehicle body includes multiple subassemblies each having a number of subcomponents. Typically, dedicated fixtures are designed for presenting and positioning each subcomponent relative to one or more subcomponents to which it is to be assembled. These fixtures require an extended lead time and significant capital investment to design and manufacture prior to use in assembling the body components. Additionally, the fixtures occupy a large amount of floor space.

### SUMMARY

A tool for assembling a first component and a second component includes a tool body with a plurality of roller elements mounted thereto. A first roller element is rotatably mounted to the tool body and is rotatable about a first axis of rotation. A second roller element is rotatably mounted to the tool body and is rotatable about a second axis of rotation nonparallel with the first axis of rotation. A third roller element is rotatably mounted to the tool body and is rotatable about a third axis of rotation nonparallel with the first axis of rotation. The second and third roller elements define a gap between one another. At least one clamping device provides clamping force directing at least one of the second and the third roller elements toward the gap. A weld head is also operatively connected to the tool body.

In one embodiment, the first roller element contacts edge surfaces of the first and second components, the second roller element contacts a first flange surface of the first component, and the third roller element contacts a second flange surface of the second component when the first and second components are in the gap. With this arrangement, the weld head is positioned to weld the flange surfaces to one another.

A system for assembling a first component and a second component includes an electronic controller, and a robotic arm operatively connected to and movable by the electronic controller. The robotic arm is operatively connected to one of the tool and the first and second components. The weld head operatively connected to the tool body is also operatively connected to the electronic controller and controllable by the electronic controller to provide a weld along a weld path as the electronic controller moves the robotic arm.

A method of assembling components includes controlling a tool via an electronic controller so that the tool is in contact with the first and the second components and provides a clamping force clamping the first and the second components to one another. The method further includes moving a robotic arm via the controller so that the tool rolls along the first and the second components, and welding the first and the second components to one another with a weld head mounted to the tool during the moving of the robotic arm. No additional clamping of the first and second components to one another need be provided other than by the tool.

The tool, the system, and the method can be used for assembling a wide variety of multiple component items, such as but not limited to vehicle body components, boats, construction equipment, lawn equipment, robots, etc. The tool, system and method may reduce production costs and lead time to introduce new multiple component items, as dedicated supports and tools for different components are not required. Complex part holding pallets and fixtures are not required as the tool enables welding of components without requiring their precise initial placement. Because the tool uses the components themselves as a guide for establishing a weld path, flexible and rapid welding with different subassemblies of different vehicle body components is enabled. When used for welding of vehicle body components, for example, the tool, system and method may reduce production costs and lead time to introduce new vehicle models.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustration in partial cross-sectional and fragmentary side view of a portion of a system for assembling vehicle components, including a tool for assembly of vehicle components.

FIG. 2 is a schematic illustration in partial cross-sectional and fragmentary side view of the tool of FIG. 1 clamping first and second vehicle body components supported on a support.

FIG. 3 is a schematic illustration in partial cross-sectional and fragmentary side view of the tool of FIG. 1 clamping third and fourth vehicle body components supported on a support.

FIG. 4 is a schematic fragmentary illustration in end view of a portion of the tool contacting the vehicle body components, with the tool body not shown for clarity.

FIG. 5 is a schematic plan view of a portion of the system and the tool showing a shielding gas nozzle, a weld head, and a camera mounted to a first portion of the tool body.

FIG. 6 is a schematic bottom view of the tool in contact with and welding flanges of the first and second vehicle body components supported on the support.

FIG. 7 is a schematic illustration in perspective view of a support for the vehicle body components.

FIG. 8 is a schematic illustration in perspective view of the system of FIG. 1 showing the support of FIG. 7 supporting first and second vehicle body components.

FIG. 9 is a schematic illustration in perspective view of another embodiment of a system for assembling vehicle components, including a tool for assembly of vehicle components.

FIG. 10 is a flow diagram of a method of assembling vehicle components.

### DETAILED DESCRIPTION

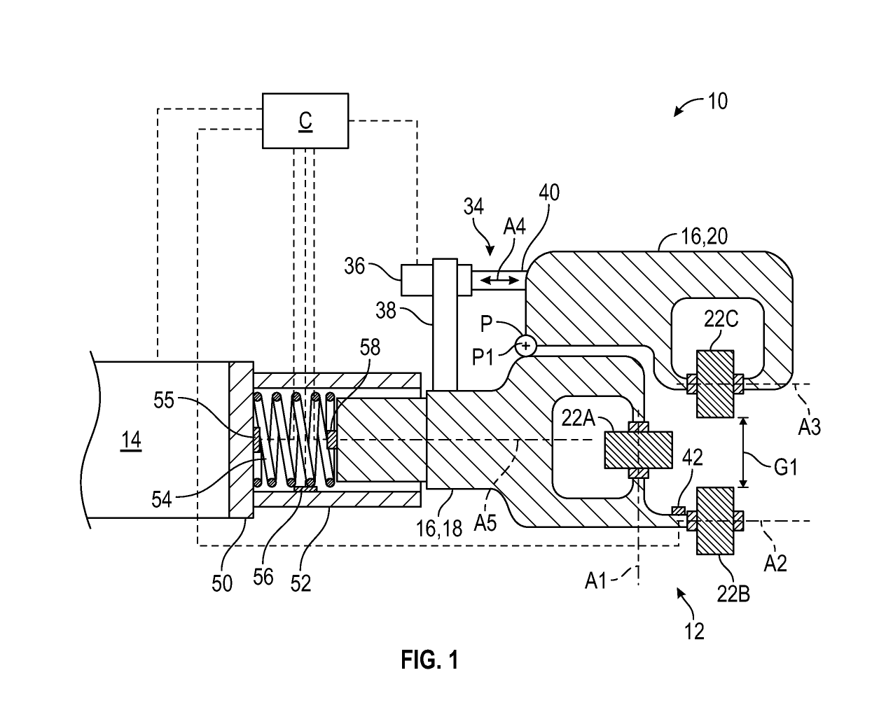

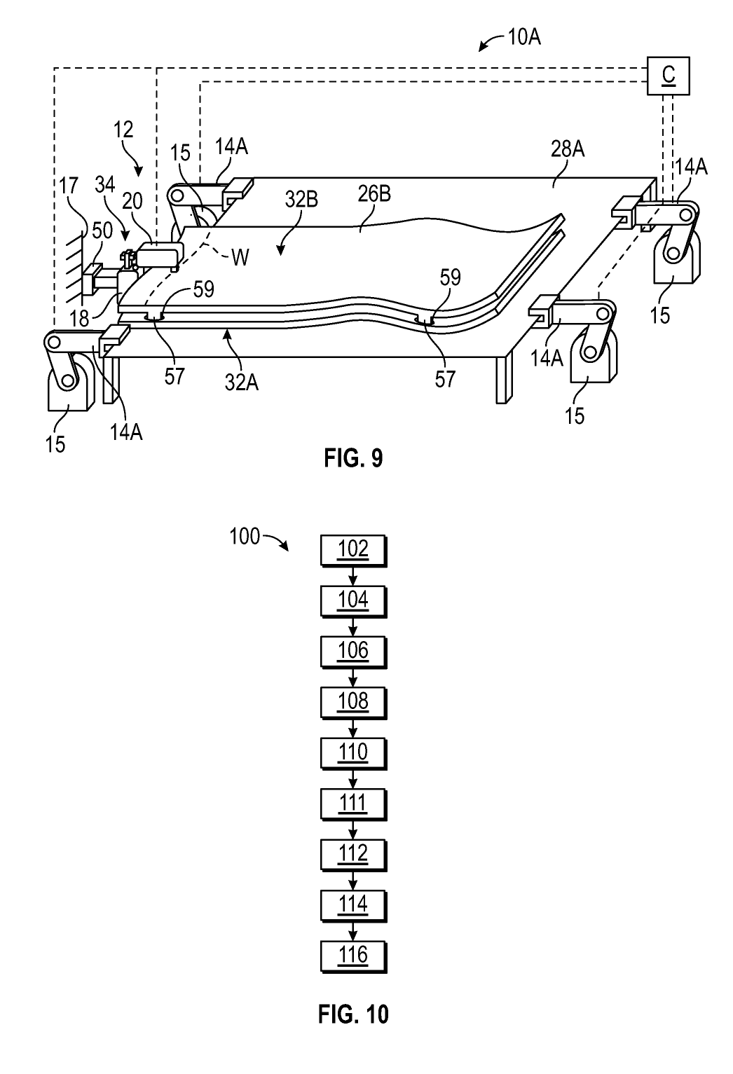

Referring to the drawings, wherein like reference numbers refer to like components throughout the views, FIG. 1 shows a system 10 for assembling components such as vehicle body components. The system includes a tool 12 that both clamps and welds vehicle body components of different configurations to one another when the vehicle body components are supported on a support 28, best shown in FIGS. 8 and 9. The vehicle body components may be stamped sheet metal, and the welding may be by laser welding, although other types of welding may be utilized. Due to the features of the tool 12 described herein, neither the tool 12 nor the support 28 are specifically configured for or limited to use with a particular component. In other words, the tool 12 enables assembly and welding of different components without the use of custom clamping fixtures specifically designed for particular components with particular dimensional configurations. Moreover, although the specific embodiments shown are described with respect to vehicle body components, the system 10, the tool 12, and the method 100 described herein, can be used for the assembly of multiple component items in a wide variety of different technologies.

More specifically, the tool 12 may be mounted to the robotic arm 14 of a robot 15 (shown in FIG. 8) controlled by an electronic controller C for multi-directional movement, such as in X, Y, and Z directions. In another embodiment of a system 10A (shown in FIG. 9), the tool 12 may be fixed to a stationary member 17, and one or more robotic arms 14A can be operatively connected to the vehicle body components 26A, 26B to move the vehicle body components 26A, 26B relative to the tool 12. For example, in the embodiment of FIG. 9, the robotic arms 14A can move a support 28A on which the vehicle body component 26A, 26B are supported. The robotic arms 14A and support 28A can function similar to a conveyor.

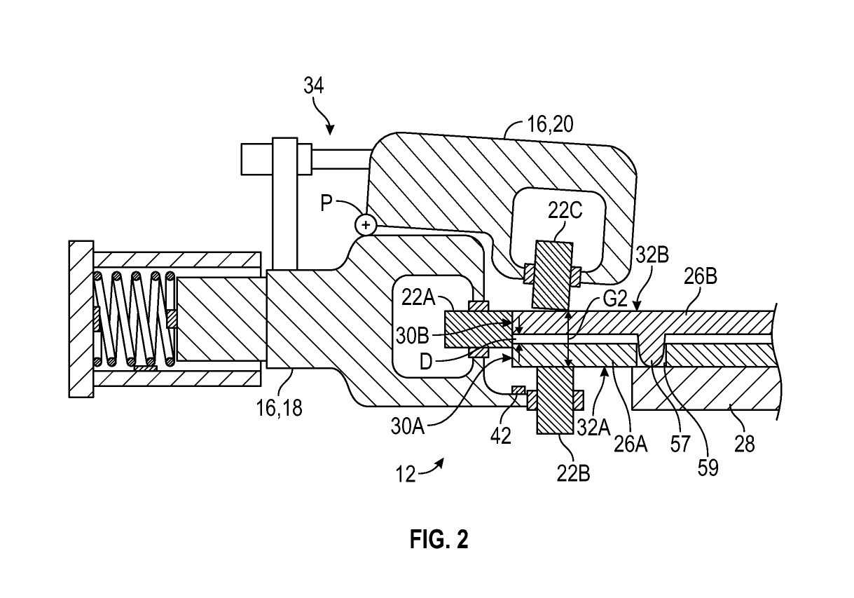

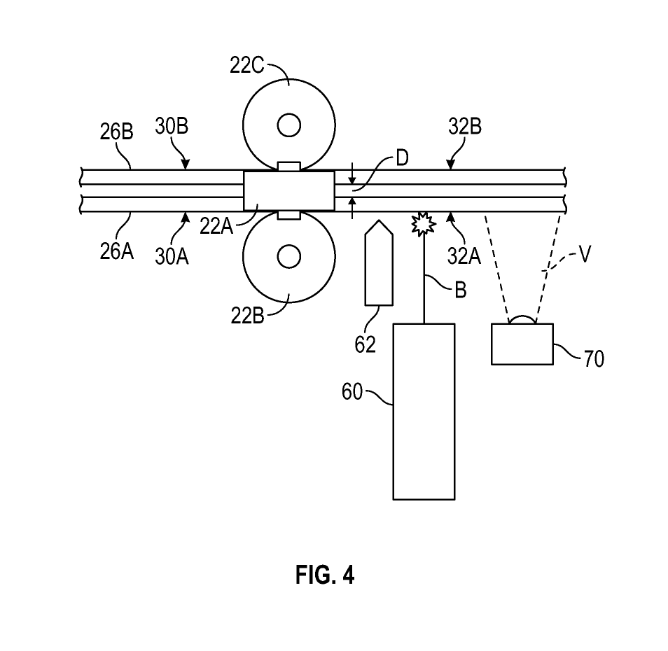

Referring again to FIG. 1, the tool 12 has a tool body 16 that includes a first body portion 18 and a second body portion 20. The tool 12 has a plurality of roller elements that contact and roll along a variety of different components, such as the vehicle body components 26A, 26B of FIG. 2, as further explained herein, enabling the tool 10 to use the vehicle body components 26A, 26B as a guide during welding by a weld head 60 (see FIGS. 4 and 6) mounted to the first body portion 18.

A first roller element 22A is rotatably mounted to the first body portion 18 of the tool body 16 such that the first roller element 22A is rotatable about a first axis of rotation A1. A second roller element 22B is rotatably mounted to the first body portion 18 of the tool body 16 such that it is rotatable about a second axis of rotation A2. The second axis of rotation A2 is at an angle relative to the first axis of rotation A1 such that it is nonparallel with the first axis of rotation A1. In the embodiment shown, the second axis of rotation A2 is substantially perpendicular to the first axis of rotation A1. A third roller element 22C is rotatably mounted to the second body portion 20 of the tool body 16 such that it is rotatable about a third axis of rotation A3. The third axis of rotation A3 is at an angle relative to the first axis of rotation A1 such that it is nonparallel with the first axis of rotation A1. In the embodiment shown, the third axis of rotation A3 is substantially perpendicular to the first axis of rotation A1. In the embodiment shown, the roller elements 22A, 22B, 22C are generally round. Although only the roller elements 22A, 22B, 22C are shown, the tool 12 may have additional roller elements mounted to the body portions 18, 20 in series or in parallel with the roller elements 22A, 22B, 22C. In FIG. 1, the second body portion 20 is positioned so that the second and third axes of rotation A2, A3 are generally parallel with one another.

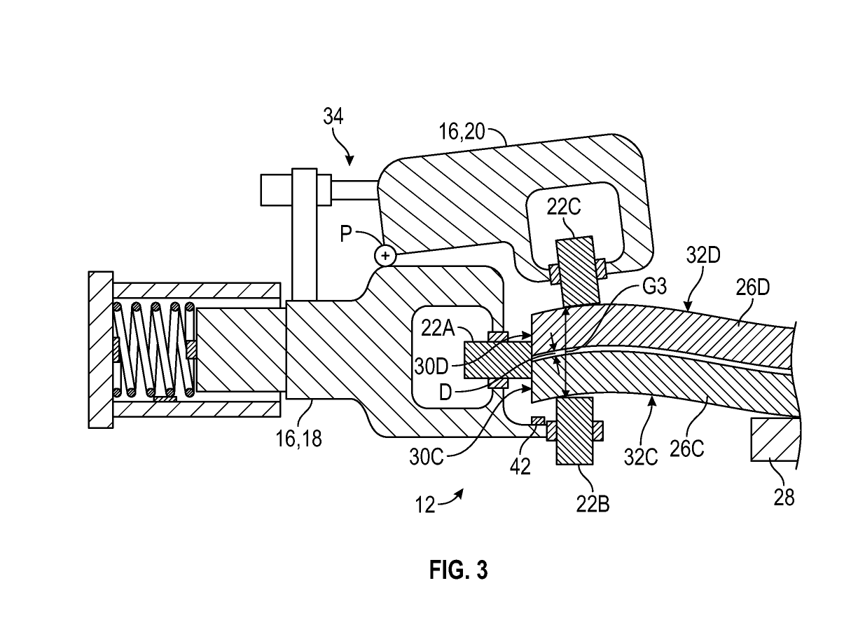

As further discussed herein, the second body portion 20 is movable relative to the first body portion 18 so that the third roller element 22C moves relative to the second roller element 22B, and the size of the gap between the roller elements 22B, 22C can be increased or decreased. Specifically, the second body portion 20 is operatively connected to, and movable relative to the first body portion 18. In the embodiment shown, the second body portion 20 is pivotably connected to the first body portion 18 at a pivot P having a pivot axis P1, such as a pivotable hinge. The second body portion 20 can thus be moved in a first rotational direction about the pivot axis P1, such as clockwise, to decrease the gap from gap G1 to gap G2 shown in FIG. 2. The second body portion 20 can also be moved in a second rotational direction about the pivot axis P1, such as counterclockwise, to increase the gap from gap G1 shown in FIG. 1 to gap G3, shown in FIG. 3. In other embodiments, the second body portion 20 could be linearly movable relative to the first body portion 18, such as with a clamping device including a linear slide with a ball screw instead of a rotary actuator. In any of these embodiments, the tool 12 can thus accommodate different stacked heights of vehicle body components in the gap, while maintaining the second and third roller elements 22B, 22C in contact with the vehicle body components. By positioning the roller elements 22A, 22B, 22C in this configuration, the tool 12 uses the vehicle body components inserted in the gap as a guide for establishing and following a weld path, as further discussed herein.

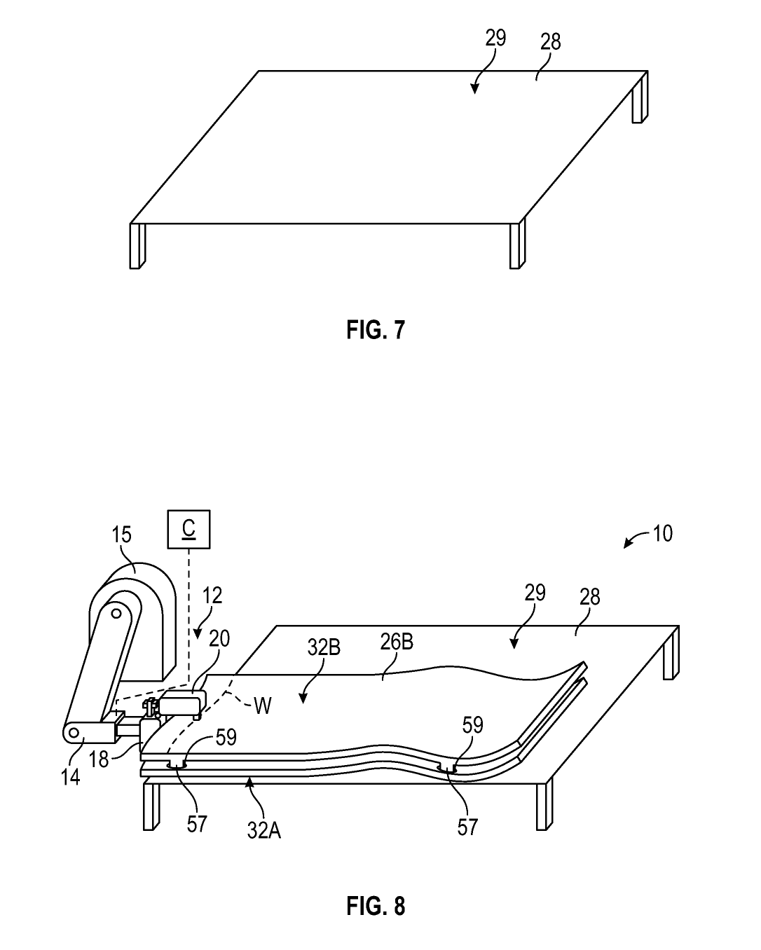

In FIG. 2, a first vehicle body component 26A and a second vehicle body component 26B are supported on a support 28. As shown in FIG. 7, the support 28 can be a simple flat surface 29 without any specific fixtures used to locate vehicle body components 26A, 26B relative to the support 28. For example, in FIG. 8, the first vehicle body component 26A is simply placed on the surface 29 of the support 28 to rest on the support 28, and the second vehicle body component 26B is stacked on and rests on the first vehicle body component 26A. FIG. 2 shows that the tool 12 is positioned so that the first roller element 22A is in contact with edge surfaces 30A, 30B of the first and second vehicle body components 26A, 26B, the second roller element 22B contacts a first flange surface 32A of the first vehicle body component 26A, and the third roller element 22C contacts a second flange surface 32B of the second vehicle body component 26B when the first and second vehicle body components 26A, 26B are on the support 28 and in the gap G2 between the roller elements 22B, 22C. The gap G2 is smaller than the gap G1, as the second body portion 20 has pivoted clockwise slightly in the view of FIG. 2 about the pivot axis P1 relative to the view of FIG. 1 to accommodate the relatively short stacked height of the flanges of the first and second vehicle body components 26A, 26B. The roller elements 22A, 22B, 22C are maintained in contact with the first and second vehicle body components 26A, 26B by the tool 12.

In FIG. 3, on the other hand, the tool 12 is positioned so that different third and fourth vehicle body components 26C, 26D are between the roller elements 22B, 22C, with first roller element 22A in contact with edge surfaces 30C, 30D of the third and fourth vehicle body components 26C, 26D, the second roller element 22B contacting a first flange surface 32C of the third vehicle body component 26C, and the third roller element 22C contacting a second flange surface 32D of the fourth vehicle body component 26D when the third and fourth vehicle body components 26C, 26D are on the support 28 and in the gap G3 between the roller elements 22B, 22C. The gap G3 is larger than the gap G1 of FIG. 1 and larger than the gap G2 of FIG. 2, as the second body portion 20 has pivoted counterclockwise slightly in the view of FIG. 2 about the pivot axis P1 to accommodate the larger stacked height of the flanges of the third and fourth vehicle body components 26C, 26D while maintaining the roller elements 26A, 26B, 26C in contact with the third and fourth vehicle body components 26C, 26D. Although the gap may vary in size, as indicated by gaps G1, G2 and G3, for purposes of discussion, references made to the gap G1 herein may include conditions when the gap is reduced in size such as to gap G2 or increased in size, such as to gap G3.

The tool 12 is also configured to clamp the vehicle body components 26A, 26B to one another within the gap G1. A clamping device 34 is mounted to the tool body 16 and is configured to apply force on the second body portion 20 tending to urge the second body portion 20 in the clockwise direction about the pivot axis P1, causing a clamping force of the third roller element 22C against vehicle body components 26B or 26D. As shown in FIG. 1, the clamping device 34 includes a motor 36 mounted to an extension 38 of the first body portion 18 and controllable by the controller C to move a lead screw 40 in either of two directions shown by the double-sided arrow A4. The controller C can thus ensure that the clamping force provided remains within a predetermined range of a predetermined clamping force when the robotic arm 14 moves the tool 12 relative to the vehicle body components 26A, 26B along a weld path W, such as the weld path W indicated in FIG. 8. In other embodiments, the tool 12 is fixed, and a robotic arm instead moves the vehicle body components 26A, 26B relative to the tool 12. As is evident in FIG. 8, any of the vehicle body components such as first and second vehicle body components 26A, 26B may have nonuniform surfaces 32A, 32B with complex, contoured topographies, causing the stacked height of the vehicle body components 26A, 26B between the roller elements 22B, 22C to increase and decrease as the tool 12 moves along the weld path W (or, alternatively, as a robotic arm moves the vehicle body components 26A, 26B relative to the tool 12). Although the gap may be varying along the weld path W, such as varying from gap G1 to gap G2 to gap G3, etc., the controller C can control the clamping force to a constant level during such movement, if desired, by controlling the motor 36 to adjust the position of the lead screw 40 and hence the second body portion 20. Any other suitable clamping device can be used to provide clamping force through the roller elements 22B, 22C on the vehicle body components placed between the roller elements 22B, 22C. In other embodiments, the motor 36 could be mounted concentric with the pivot axis P1.

A force measurement device 42 provides a sensor signal to the controller C indicative of the clamping force, thereby allowing the controller C to monitor and adjust the clamping force to remain substantially constant or within predetermined parameters. In FIG. 1, the force measurement device 42 is a strain gauge mounted to the first body portion 18 adjacent the second roller element 22B. In still other embodiments, the clamping device can be a passive torsion spring arranged concentrically about the pivot axis P1 to provide a constant angular biasing force biasing the second body portion 20 clockwise in FIG. 1. Moreover, the clamping device could be a linear spring. In any of these embodiments, the clamping force is provided by the tool 12 that can be used with a variety of different vehicle body components, instead of by fixtures that must be designed in conformance with the specific geometry of certain vehicle body components.

In addition to enabling a controlled and/or relatively constant clamping force, the tool 12 is configured to provide compliance in a direction generally perpendicular to the first axis of rotation A1 of the first roller element 22A, indicated by compliance axis A5. A compliant device includes a base 50, a guide 52, and a compliant member 54. The tool 12 is mounted to the robotic arm 14 at the base 50 or, in other embodiments, the base 50 is mounted to a fixed member. The guide 52 extends from the base as a generally cylindrical member surrounding a portion of the first body portion 18 and thereby generally limiting movement of the first body portion 18 relative to the base 50 to movement along and/or around the compliance axis A5. The compliant member 54 allows movement of the first body portion 18 relative to the base 50 along and/or around the compliance axis A5, but provides a biasing force to bias the first body portion 18 and the roller elements 22A, 22B mounted thereto in a direction away from the base 50. Depending on the width of and shape of the guide 52, the first body portion 18 may be able to rotate as well as translate. In FIG. 1, the compliant member 54 is a compression type coil spring. Other suitable compliant members may be used within the scope of the present teachings.

As indicated in FIGS. 2 and 3, the compliant device 50, 52, 54 biases the roller element 22A against the respective edge surfaces 30A, 30B, or 30C, 30D of the vehicle body components 26A, 26B, or 26C, 26D positioned between the roller elements 22B, 22C. The roller element 22A is referred to as a guide roller as its constant contact with the edge surfaces 30A, 30B or 30C, 30D via the compliance device guides the tool 12 along the edge surfaces. This ensures proper positioning of the weld head 60 and associated weld laser beam B (shown in FIGS. 4-6) relative to the flange surfaces 32A, 32B, or 32C, 32D, and thus proper location of a weld path W along the vehicle body components 26A, 26B, or 26C, 26D.

The compliant device 50, 52, 54 and clamping device 34 thus constantly position the tool 12 relative to the vehicle body components, using the vehicle body components themselves as a guide (i.e., the edge surfaces 30A, 30B, or 30C, 30D and the flange surfaces 32A, 32B, or 32C, 32D). The robotic arm 14 thus need not position the tool 12 as precisely relative to the vehicle body components 26A, 26B, or 26C, 26D to determine the appropriate weld path as it would need to without the aid of the compliant device 50, 52, 54 and the clamping device 34.

Referring again to FIG. 1, the compliant device 50, 52, 54 can be equipped with a force measurement device such as a strain gauge 55, operatively connected to the compliant member 54 and operable to measure the variation in force applied by the compliant device 50, 52, 54 to the vehicle body members 26A, 26B or 26C, 26D via the roller element 22A. Still further, a movement sensor 56 can be operatively connected to either the first body portion 18 or the base 50 to measure displacement of the first tool body portion 18 relative to the base 50 along the compliance axis A5. In FIG. 1, the movement sensor 56 is shown as a Hall Effect sensor mounted to the guide 52 and operable to determine the movement of the body portion 18 by reference to sensed movement of a magnet 58 mounted to the body portion 18. The optional strain gauge 55 and movement sensor 56 are in communication with the controller C to provide sensor signals to the controller C. The controller C may use the communicated sensor signals such as to adjust the position of the tool body 16 via the robotic arm 14, or to adjust the clamping force provided through the clamping device 34.

Moreover, as the tool 12 is moved along the vehicle body components 26A, 26B, or 26C, 26D by the robotic arm 14 (or the vehicle body components 26A, 26B, or 26C, 26D are moved relative to the tool 12 in an embodiment in which the tool 12 is fixed rather than mounted to a robotic arm 14), the clamping force of the roller element 22C and the biasing force along the compliance axis AS provided through the roller element 22A can assist in aligning the vehicle body components 26A, 26B, or 26C, 26D relative to one another. For example, if the vehicle body components 26A, 26B, or 26C, 26D are stamped in various locations with self-aligning features such as protrusions 57 that mate with recesses 59 (as shown in FIGS. 2, 8, and 9), the clamping force and biasing force can aid in mating these features with one another. A predetermined clamping force provided by the clamping device 34 may be configured to align the adjacent vehicle body components 26A, 26B, or 26C, 26D sufficiently with one another while ensuring a predetermined standoff distance D (shown in FIGS. 2 and 3) between the vehicle body components 26A, 26B, or 26C, 26D is maintained along the weld path W, as may be desired for laser weld quality.

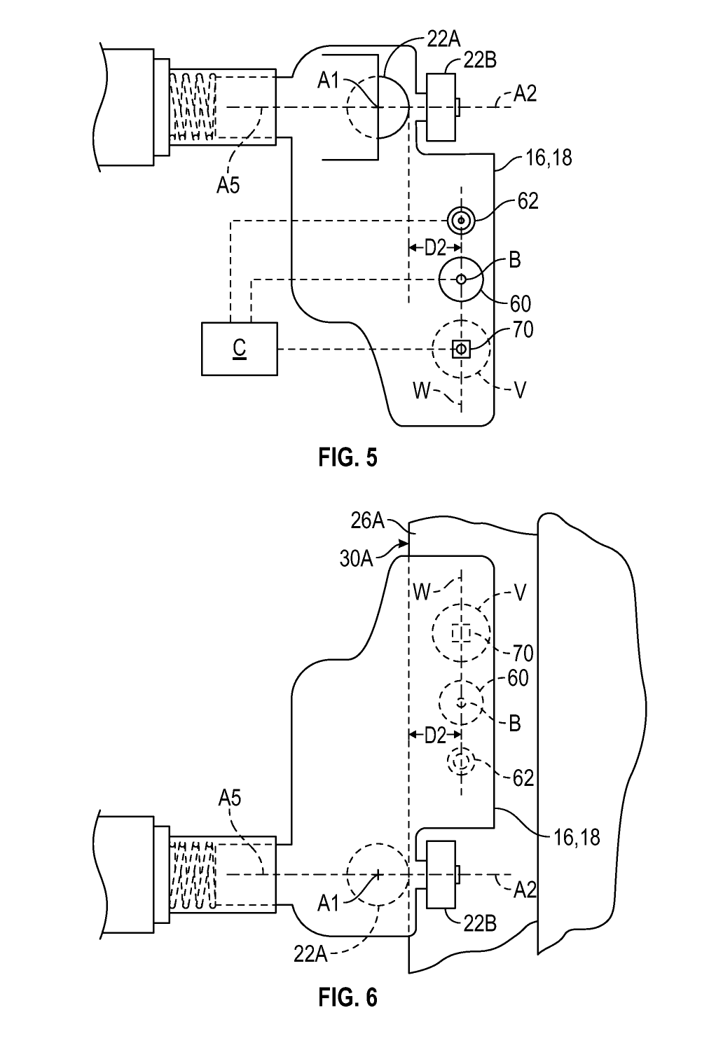

FIGS. 4-6 show the position of the weld head 60 relative to the roller elements 22A, 22B, 22C. FIGS. 5 and 6 show that the weld head 60 is supported by the first body portion 18 and directs the weld laser beam B from the first tool body potion 18 (upward in FIG. 5), so that the weld laser beam B falls on the flange surface 32A shown in FIG. 2. In other embodiments, the weld head 60 may be for another type of welding such as resistance welding. When the weld head 60 is for laser welding, a shielding gas nozzle 62 is mounted to the first body portion 18 between the laser weld head 60 and the second roller element 22B. The gas nozzle 62 is configured to disperse an inert gas toward the first vehicle body component 26A to protect the weld from atmospheric gases that could impact weld characteristics. FIG. 4 schematically shows the relative positions of the weld head 60 and the roller element 22B, but with the tool body 16 removed for purposes of clarity. Accordingly, the weld head 60 is operable to weld the first and second vehicle body components 26A, 26B to one another at the flange surfaces 32A, 32B.

As best shown in FIGS. 5 and 6, a distance D2 from the roller element 22A to the center of the weld head 60 at the laser beam B is also the distance from the edge surface 30A of the first vehicle body component 26A to the weld path W. Because the compliant device 50, 52, 54 ensures that the roller element 22A is biased into contact with the edge surface 30A, the weld path W is determined by the geometry of the vehicle body components 26A, 26B themselves and not by fixturing and locating of the vehicle body components 26A, 26B relative to the support 28. The controller C and robotic arm 14 also need not precisely locate and track the vehicle body components 26A, 26B to determine the weld path W. Moreover, when the tool 12 is used to clamp and weld different vehicle body components, such as vehicle body components 26C, 26D, the compliant device 50, 52, 54 and clamping device 34 will likewise ensure that the tool 12 follows the edge surfaces 30C, 30D and flange surfaces 32C, 32D, so that a weld path along the vehicle body components 26C, 26D will be determined by the geometry of the vehicle body components 26C, 26D themselves, and not by fixturing and locating of the vehicle body components 26C, 26D relative to the support 28 or relative to the robotic arm 14.

Referring still to FIGS. 4-6, the tool 12 may include an optional camera 70 mounted to the first body portion 18 such that a field of vision V of the camera 70 includes the weld path W. The controller C can be operatively connected with the camera 70 such that recorded visual information of the weld is processed by a machine vision program stored on the controller C. The machine vision program is operable to determine weld characteristics based on the visual information.

The controller C and the camera 70 are together referred to as a vision system. Any one or more of various arrangements of vision systems may be used. In one example, the camera C can be a three-dimensional camera that provides light over the field of vision, creating a stripe of light (or other pattern) across the first vehicle body component 26A as the tool 12 moves relative to the first vehicle body component 26A. In various embodiments, the light may be a laser beam. The camera 70 and controller C may be configured to locate various features such as holes or flanges of the first vehicle body component 26A. Alternatively or in addition, the controller C may register the contours of the component 26A based on the various depths of the light on the surface of the component 26A. In some embodiments, multiple cameras 70 may be mounted on the tool 12 to provide stereo vision of the weld path W. In any of the embodiments, the camera 70 is operatively connected to the controller C. Based on the information received from the camera 70, the controller C can control the robotic arm 14, the clamping device 34, and the weld head 60.

Optionally, additional welding can be accomplished by a robotically positioned “traditional” laser welding head. A traditional laser welding head will have “fixed” optics that only point in a single direction relative to the support 28. The “traditional” laser welder will also typically have optics that provide for a relatively short standoff distance (e.g., 100 mm) from the point of welding.

Additional welding may also be accomplished by a robotically positioned “remote” laser welding head where a laser beam and optics are inside of the head. The optics have a relatively long focal length that also includes a controllable mirror allowing the laser beam to be quickly re-aimed to different positions at distances of about 1 meter from the remote laser welding head. Many positions can be welded from a stationary robot position. Then the robot can reposition the remote laser welding head to new positions as needed to make welds in other locations.

Still further, additional welding can be accomplished by one or more stationary (fixed) remote laser weld heads which are mounted on a fixed structure (not on a robot). Each remote laser welding head has a laser beam and optics having a relatively long focal length that also includes a controllable mirror allowing the laser beam to be quickly re-aimed to different positions at distances of about 1 meter or more from the remote laser welding head. Since a remote laser welding head has a finite window of coverage (due to limitations on the angle of the mirror) e.g., a one square meter window), additional heads may be used.

With reference to the system 10 and tool 12 of FIGS. 1-8, FIG. 10 illustrates a method 100 of welding vehicle body components, such as stamped sheet metal vehicle body panels, including first and second vehicle body components 26A, 26B. The method 100 includes block 102, placing the first and the second vehicle body components on a first support 28, and block 104, controlling a tool 12 via an electronic controller C so that the tool 12 is simultaneously in contact with the edge surfaces 30A, 30B of a first and a second vehicle body component 26A, 26B, and with flange surfaces 32A, 32B of the first and second vehicle body components 26A, 26B, and also provides a clamping force clamping the first and second vehicle body components 26A, 26B to one another. Block 104 may include controlling a clamping device so that the clamping force is a predetermined clamping force. For example, in an embodiment in which the clamping device is a controlled servo motor type actuator, rather than a passive spring 54, the clamping force can be controlled.

The method 100 may also include block 106, moving the robotic arm 14 via the controller C so that the tool 12 rolls along the edges 30A, 30B and the flange surfaces 32A, 32B. In other embodiments, the controller C can control movement of a robotic arm holding the first and second vehicle body components 26A, 26B while the tool 12 remains stationary. While moving the robotic arm 14, the method 100 may also include block 108, welding the first and second vehicle body components 26A, 26B to one another at the flange surfaces 32A, 32B with a weld head 60 mounted to the tool 16 without any additional clamping of the vehicle body components 26A, 26B to one another other than by the tool 16.

After the welding is completed, the method 100 may include block 110, moving the robotic arm 14 via the electronic controller C so that the tool 12 is out of contact with the welded first and second vehicle body components 26A, 26B. Because the tool 12 is not component-specific, it can then be used to weld differently configured vehicle body components 26C, 26D to one another. For example, the method 100 can include block 111, placing the third and the fourth vehicle body components 26C, 26D on the support 28 during the welding of the flange surfaces of the third and the fourth vehicle body components 26C, 26D, the support 28 thus being operable independent of the geometric configurations of the vehicle body components 26C, 26D.

The method can include block 112, controlling the robotic arm 14 via the electronic controller C so that the tool 12 attached to the robotic arm 14 is simultaneously in contact with edge surfaces 30C, 30D of a third and a fourth vehicle body component 26C, 26D, and with flange surfaces 32C, 32D of the third and fourth vehicle body components, and provides a clamping force clamping the third and fourth vehicle body components 26C, 26D to one another at the flange surfaces 32C, 32D. The edge surfaces 30A, 30B, and the flange surfaces 32A, 32B of the first and the second vehicle body components 26A, 26B have a different geometric configuration than the edge surfaces 30C, 30D and the flange surfaces 32C, 32D of the third and the fourth vehicle body components 26C, 26D. The tool 12 can nonetheless be used to weld the vehicle body components 26C, 26D to one another by moving the robotic arm 14 via the controller C in block 114 so that the tool 12 rolls along the edge surfaces 30C, 30D of the third and the fourth vehicle body components 26C, 26D and the flange surfaces 32C, 32D of the third and fourth vehicle body components, and, in block 116 by welding the flange surfaces 32C, 32D of the third and fourth vehicle body components 26C, 26D to one another with the weld head 60 while moving the tool 12 according to block 114.

While the best modes for carrying out the many aspects of the present teachings have been described in detail, those familiar with the art to which these teachings relate will recognize various alternative aspects for practicing the present teachings that are within the scope of the appended claims.

1. A tool for assembling a first component and a second component, the tool comprising:
a tool body;
a first roller element rotatably mounted to the tool body and rotatable about a first axis of rotation;
a second roller element rotatably mounted to the tool body and rotatable about a second axis of rotation nonparallel with the first axis of rotation;
a third roller element rotatably mounted to the tool body and rotatable about a third axis of rotation nonparallel with the first axis of rotation;
wherein the second and third roller elements define a gap between one another;
at least one clamping device that provides clamping force directing at least one of the second and the third roller elements toward the gap; and
a weld head operatively connected to the tool body.

2. The tool of claim 1, wherein the first roller element contacts edge surfaces of the first and second components, the second roller element contacts a first flange surface of the first component, and the third roller element contacts a second flange surface of the second component when the first and second components are in the gap; and
wherein the weld head is positioned to weld the flange surfaces to one another.

3. The tool of claim 1, wherein the tool body includes a first body portion and a second body portion operatively connected to the first body portion;
wherein the second body portion is movable relative to the first body portion;
wherein the clamping device is mounted to the tool body and is configured to provide clamping force against the second body portion to thereby move the second body portion relative to the first body portion so that the third roller element moves toward the second roller element and decreases the gap.

4. The tool of claim 3, wherein the clamping device is an actuator having a motor.

5. The tool of claim 3, further comprising:
a force measurement device operatively connected to the tool body and configured to measure the clamping force.

6. The tool of claim 5, wherein the force measurement device is a strain gauge mounted to the first body portion adjacent the second roller element.

7. The tool of claim 1, wherein the weld head is a laser weld head; and further comprising:
a gas nozzle mounted to the tool body between the laser weld head and one of the second and third roller elements; and wherein the gas nozzle is configured to disperse an inert gas.

8. The tool of claim 3, further comprising:
a camera mounted to the tool body; wherein the camera has a field of vision that includes a weld path associated with the weld head; and
in combination with a controller operatively connected with the camera and having a machine vision program operable to determine weld quality of a weld along the weld path.

9. The tool of claim 3, further comprising:
a camera mounted to the tool body; wherein the camera has a field of vision; and
in combination with a controller operatively connected to the camera and having a machine vision program operable to determine weld characteristics of a weld provided by the weld head and within the field of vision.

10. The tool of claim 1, further comprising:
a base; and
a compliant member connecting the base to the tool body and configured such that the tool body is movable relative to the base in response to a variation in the clamping force o.

11. The tool of claim 10, wherein the compliant member is a spring.

12. The tool of claim 10, further comprising:
at least one of a force measurement device operatively connected to the compliant member and operable to measure the variation in force, and a movement sensor operatively connected to one of the tool body and the base and configured to measure displacement of the tool body relative to the base.

13. A system for assembling a first component and a second component, the system comprising:
an electronic controller;
a robotic arm operatively connected to one of the tool and the first and second components and movable by the electronic controller;
a tool having:
a tool body;
a first roller element rotatably mounted to the tool body and rotatable about a first axis of rotation;
a second roller element rotatably mounted to the tool body and rotatable about a second axis of rotation nonparallel with the first axis of rotation;
a third roller element rotatably mounted to the tool body and rotatable about a third axis of rotation nonparallel with the first axis of rotation;
wherein the second and third roller elements define a gap between one another;
at least one clamping device that provides clamping force directing at least one of the second and the third roller elements toward the gap; and
a weld head operatively connected to the tool body and to the electronic controller and controllable by the electronic controller to provide a weld along a weld path as the electronic controller moves the robotic arm to move one of the tool and the vehicle body components along the weld path.

14. The system of claim 13, wherein the tool includes a base fixed to the robotic arm;
a compliant member connecting the base to the tool body such that the tool body is movable relative to the base and the robotic arm along a compliance axis in response to a variation in the clamping force caused when the first and second components are placed in the gap and the controller moves the robotic arm to roll the roller elements along the first and second components.

15. The system of claim 13, wherein the tool body includes a first body portion and a second body portion;
wherein the second body portion is movable relative to the first body portion;
wherein the clamping device is mounted to the tool body and is configured to provide clamping force against the second body portion to thereby move the second body portion relative to the first body portion so that the third roller element moves toward the second roller element and decreases the gap.

16. The system of claim 13, further comprising:
a support positioned such that the first component rests on and is supported by the support when the first and second components are in the gap and the weld head welds the first component to the second component.

17. A method of assembling components, the method comprising:
controlling a tool via an electronic controller so that the tool is in contact with a first and a second component and provides a clamping force clamping the first and the second components to one another;
moving a robotic arm via the controller so that the tool rolls along the first and the second components; and
welding the first and the second components to one another with a weld head mounted to the tool during said moving.

18. The method of claim 17, further comprising:
controlling a clamping device so that the clamping force is within a predetermined range of a predetermined clamping force.

19. The method of claim 17, further comprising:
after said welding, moving the tool via the electronic controller so that the tool is out of contact with the welded first and second components;
controlling the tool via the electronic controller so that the tool is in contact with a third component and a fourth component and provides a clamping force clamping the third and fourth components to one another;
wherein the first and the second components have a different geometric configuration than the third and the fourth components;
moving the robotic arm via the controller so that the tool rolls along the the third and the fourth components; and
welding the third and fourth components to one another with the weld head during said moving.

20. The method of claim 19, further comprising:
placing the first and the second components on a support during said welding of the first and the second components; and
placing the third and the fourth components on the support during said welding of the third and the fourth components, the support thus being operable during said welding independent of the geometric configurations of the components.
